(19) United States
(12) Patent Application Publication
(10) Pub. No.: US 2026/0080200 A1
(43) Pub. Date: Mar. 19, 2026

(54) SYSTEM AND METHODS FOR A BIOTHERMAL RFID SENSOR

(71) Applicant: TROVAN LIMITED, Douglas (IM)

(72) Inventors: Frederic SACKSTEDER, Bruebach (FR); José Luis GEIJO, Marin-Epagnier (CH)

(21) Appl. No.: 18/884,232

(22) Filed: Sep. 13, 2024

(51) Int. Cl. G06K 19/07

(52) U.S. Cl. CPC G06K 19/0717

(57) ABSTRACT

Disclosed are systems and methods for integrating temperature sensors into RFID tags. In some implementations, the RFID tag includes a microchip with an integrated temperature sensor, an antenna(s), and a core. The RFID tag can store temperature data and transmit it when powered by the electromagnetic field of the reader, or by way of an internal power source, according to some implementations. The RFID tag is configured with a novel structured 64-bit code structure that includes synchronization bits, information bits and error detection bits, thereby ensuring communicability of the captured temperature sensor data, among other benefits.

### FIELD OF THE DISCLOSURE

The present disclosure relates to Radio Frequency Identification (RFID) tags, and more particularly, to an RFID tag with an integrated temperature sensor(s) for use in 64-bit RFID platforms.

### SUMMARY OF THE DISCLOSURE

Wireless data transmission technology has become increasingly prevalent in various applications, including inventory management, asset tracking, and access control. RFID tags, which can be either passive, active, or semi-passive, are used to store and transmit data wirelessly to readers. Passive tags rely on the electromagnetic field generated by the reader to power the tag and facilitate communication. Active tags have an internal power source that allows them to transmit data over longer distances and provide continuous monitoring. Semi-passive tags combine elements of both passive and active tags, using a battery to power the sensor while relying on the reader for data transmission.

Temperature monitoring is a requirement in many industries, such as healthcare, food and beverage, logistics, among others. Traditional methods of temperature monitoring often involve manual checks or standalone sensors that require separate data collection and management systems. Integrating temperature sensors into tags as disclosed herein offers a streamlined solution for real-time temperature monitoring and data logging. Existing temperature sensor tags face limitations in terms of integration with newer temperature sensing technology, such as those integrated into microchips. Therefore, there is a need for improved temperature sensor tags that can provide reliable and efficient temperature monitoring in various environments.

To that end, the disclosed system and methods provide a novel RFID tag with integrated temperature sensing capabilities and functionality, as discussed herein. In some embodiments, the disclosed RFID tag can be utilized in connection with existing RFID systems and infrastructure. For example, the RFID tag disclosed herein, and/or other types of RFID tags, may be configured with the disclosed temperature sensing code structure, which enables 9 digit or even 10 digit temperature outputs from a microchip measurement of a temperature sensor. In some embodiments, the disclosed code structure includes a first temperature output value (e.g., MLB) to be stored at the 14th bit and/or 13th non-parity bit (e.g., D34), where the temperature segment includes 10 temperature bits and at least 3 parity bits, wherein the 3 parity bits ensure integrity of the temperature data. In some embodiments, the temperature segment includes 9 temperature bits and at least 3 parity bits. In some embodiments, the parity bit is not the last number in a 4 bit sequence.

Accordingly, as discussed herein, the integration of temperature sensors into RFID tag systems, as described herein, can be used in many technical, operational, and logistical environments. From a technological perspective, the inclusion of temperature sensors in RFID tags enables real-time temperature monitoring and data logging, which is essential for industries such as healthcare, food and beverage, and logistics. Additionally, it precludes potential errors associated with manual temperature checks and conserves critical resources by automating the data collection process. In the operational domain, the integration of temperature sensors facilitates more efficient inventory management and asset tracking, elevating the caliber of data accuracy and enhancing operational efficiency. This integration improves compliance with industry regulations, quality control, and auditing processes. On a logistical level, the ability to monitor temperature in real-time can prevent spoilage of perishable goods, ensure the integrity of medical supplies, and optimize transportation conditions. Thus, the integration of temperature sensors into RFID tags contributes to a more reliable and efficient system, which may be in concert with a user's operational requirements (e.g., in warehouses, during transportation, or in healthcare facilities).

Accordingly, in some embodiments, the instant disclosure provides a novel RFID tag system with integrated temperature sensing capabilities and code outputs configured to be compatible with 64 bit RFID platforms. In some embodiments, the RFID tag, such as a passive, active, or semi-passive tag, may be used to render temperature data accessible in real-time during various applications such as inventory management, asset tracking, and access control within warehouses, transportation systems, or healthcare facilities.

According to some embodiments, the disclosed RFID tag system described herein can include one or more of: a microchip with an integrated temperature sensor, one or more antennas, a core, and a protective encapsulation. The RFID tag also can include memory components, such as EEPROM or FRAM, for example, for storing data (as within storage of the microchip), and security features such as encryption, authentication, and access control mechanisms to protect the data stored and transmitted by the RFID tag. The RFID tag assembly can include a temperature sensor that collects temperature data and transmits it when powered by the electromagnetic field of the reader or its internal power source. Additional features include tamper detection mechanisms and robust security measures to ensure data integrity and confidentiality.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1A illustrates a non-limiting system architecture according to some embodiments of the present disclosure;

FIG. 1B depicts a simplified diagram of an RFID tag with a single antenna according to some embodiments of the present disclosure;

FIG. 1C illustrates a simplified diagram of an RFID tag with two antennas according to some embodiments of the present disclosure;

FIG. 2 shows the inductive coupling between an RFID reader and an RFID tag according to some embodiments of the present disclosure;

FIG. 3 illustrates the 64-bit code structure read by the system RFID reader according to some embodiments of the present disclosure;

FIG. 4 shows the 64-bit code structure for an RFID tag with integrated temperature sensor data according to some embodiments of the present disclosure; and

FIG. 5 illustrates a workflow of executable steps by an RFID microchip according to some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4th or 5th generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

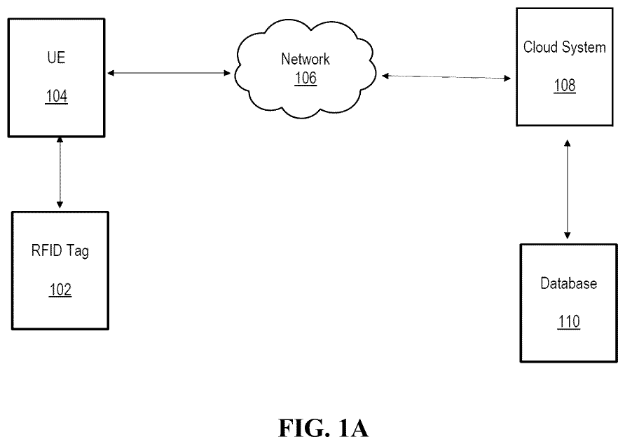

Certain embodiments and principles will be discussed in more detail with reference to the figures. With reference to FIG. 1A, depicted is non-limiting system architecture according to some embodiments of the present disclosure. The depicted system includes an RFID tag 102, user equipment (UE) 104, a network 106, a cloud system 108, and a database 110. In some embodiments, UE 104 in this non-limiting example can include, but is not limited to, an RFID Reader (e.g., low frequency (LF) reader, near field communication (NFC) reader, and the like), mobile phone, and/or other device configured to send and receive radio frequency (RF) signals, including LF and/or NFC RF signals, as further described herein.

In some embodiments, such as those depicted in FIGS. 1B and 1C, the RFID tag 102 includes various components that enable the tag to store and transmit data wirelessly to the UE 104. The RFID tag 102 can be passive, active, or semi-passive, depending on its power source and communication capabilities. In some embodiments, the RFID tag can include a microchip and temperature sensor as part of an integrated circuit (IC). In some embodiments, the microchip includes a temperature sensor configured to collect temperature data and transmit the temperature data when powered by the electromagnetic field of the reader or its internal power source.

Accordingly, reference to the microchip and temperature sensor, as discussed herein, will be with reference to them as integrated components as part of an IC; however, one of skill in the art should understand that such components can be separate and connected on the core (e.g., ferrite core) of the RFID, without departing from the scope of the instant disclosure.

As discussed supra, UE 104 can include an electronic device that communicates with the RFID tag 102 to read the data stored on the RFID tag 102. Thus, the UE 104, which as above can be a handheld reader, a mobile device, or any other equipment capable of interacting with RFID tags, can transmit/communicate the collected data over the network 106 for further processing.

The network 106 facilitates communication between the UE 104 and the cloud system 108. The network 106 can be a wireless network, a wired network, or a combination of both, providing the necessary infrastructure for data transmission.

In the case of a wireless network, the network 106 may include various wireless communication technologies such as Wi-Fi, cellular networks (e.g., 4G, 5G), Bluetooth®, Zigbee®, or other radio frequency (RF) communication protocols. These wireless technologies enable the UE 104 to transmit data to the cloud system 108 without the need for physical connections, offering flexibility and mobility in various environments. For example, in a logistics application, a handheld RFID reader (UE 104) can wirelessly transmit temperature data from RFID tags attached to perishable goods to the cloud system 108 via a cellular network, ensuring real-time monitoring during transportation.

In the case of a wired network, the network 106 may include Ethernet, fiber optics, or other wired communication technologies. Wired networks provide a stable and high-speed connection, which is particularly useful in fixed installations where mobility is not a primary concern. For example, in a warehouse setting, fixed RFID readers (UE 104) can be connected to the cloud system 108 via Ethernet cables, ensuring reliable and continuous data transmission for inventory management and temperature monitoring.

In some embodiments, the network 106 may include and/or be a combination of wireless and wired technologies, leveraging the advantages of each. For example, a hybrid network can use wireless communication for mobile devices and wired connections for fixed installations, providing a comprehensive and robust infrastructure for data transmission. This combination ensures that data from RFID tags can be collected and transmitted efficiently, regardless of the specific application or environment.

Additionally, the network 106 may include various network components such as routers, switches, gateways, and access points to manage and route data traffic between the UE 104 and the cloud system 108. These components ensure that data is transmitted securely and efficiently, minimizing latency, and maximizing data integrity. For example, in a healthcare application, temperature data from RFID tags on medical supplies can be transmitted through a secure network infrastructure to the cloud system 108, ensuring compliance with data privacy regulations and enabling real-time monitoring and alerts.

In some embodiments, the cloud system 108 includes a centralized platform that receives data from the UE 104, which may include data from the RFID tag 102, via the network 106. The cloud system 108 processes and stores the data, making it accessible for various applications. The cloud system can perform real-time data analysis, logging, and/or monitoring, ensuring that the temperature data collected by the RFID tag 102 is available for decision-making and reporting.

Upon receiving data from the UE 104, the cloud system 108 initiates a series of processes to handle the incoming information. In some embodiments, these processes include one or more of data validation, transformation, and enrichment to ensure the data is accurate, consistent, and meaningful. For example, temperature readings from the RFID tag 102 may be validated against predefined thresholds to detect anomalies or errors.

According to some embodiments, cloud system 108, and/or devices operating via system 108, connected to system 108 and/or within system 108 can provide functionality for real-time data analysis. By leveraging advanced analytics, inclusive of known or to be known artificial intelligence (AI) and/or machine learning (ML) algorithms, the cloud system 108 can provide insights and predictions based on the collected temperature data. For example, in a logistics application, the system can predict potential spoilage of perishable goods by analyzing temperature trends and alerting stakeholders to take preventive actions.

In some embodiments, in addition to real-time analysis, the cloud system 108 can support data logging and historical data storage. This capability allows for the creation of comprehensive records of temperature data over time, which can be crucial for compliance with industry regulations, quality control, and auditing purposes. For example, in the healthcare industry, maintaining a historical log of temperature data for vaccines ensures compliance with storage requirements and facilitates traceability.

According to some embodiments, monitoring is another function of the cloud system 108. In some embodiments, cloud system 108 can continuously track the temperature data from the disclosed RFID tags and generate alerts or notifications when certain conditions are met. For example, if the temperature of a refrigerated container exceeds a safe limit, the system can send an immediate alert to the responsible personnel, enabling them to take corrective actions promptly.

Furthermore, the cloud system 108 supports integration with other enterprise systems and applications through APIs (Application Programming Interfaces) in accordance with some embodiments. This interoperability allows for seamless data exchange and collaboration across different platforms, enhancing the overall efficiency and effectiveness of the temperature monitoring solution. For example, temperature data from the cloud system 108 can be integrated with a company's inventory management system to optimize stock levels based on real-time conditions.

According to various embodiments the cloud system 108 employs robust security measures, including encryption, authentication, and access control, to protect the data from unauthorized access and breaches. Compliance with industry standards and regulations, such as GDPR (General Data Protection Regulation) and HIPAA (Health Insurance Portability and Accountability Act), for example.

In addition to the security measures implemented in the cloud system 108, the RFID tag 102 includes one or more security features to ensure the integrity and confidentiality of the data it stores and transmits.

In some embodiments, the RFID tag 102 employs encryption techniques to protect the data transmitted between the tag and the reader. Encryption ensures that even if the data is intercepted during transmission, it cannot be easily read or tampered with by unauthorized parties. In some embodiments RFID 102 is configured to execute encryption that includes one or more of AES (Advanced Encryption Standard) and DES (Data Encryption Standard). These algorithms provide a high level of security by converting the data into a coded format that can only be deciphered by authorized devices with the correct decryption key.

In some embodiments, authentication mechanisms can be used to verify the identity of the RFID reader and the RFID tag 102 before any data exchange occurs. This ensures that only authorized readers can access the data stored on the RFID tag 102. In some embodiments, mutual authentication protocols, such as challenge-response authentication, may be employed. In this process, for example, the reader sends a challenge to the tag, which must respond with the correct answer based on a shared secret or cryptographic key. If the response is correct, the reader is authenticated, and data exchange can proceed.

In some embodiments, access control features are embedded in the RFID tag 102 to restrict access to certain memory areas or functions. This ensures that only authorized users or devices can read or write specific data on the tag. Access control can be implemented using passwords or access codes stored in the tag's reserved memory. For example, a 32-bit access password can be required to read or write data in the user memory area, while a separate kill password can be used to permanently disable the tag if needed.

In some embodiments, RFID tag 102 can include secure memory areas, such as those in microchip 124, that are protected against unauthorized access and tampering. These secure memory areas can store sensitive information, such as encryption keys, authentication credentials, and access control settings. The data stored in secure memory is typically encrypted and can only be accessed by authorized devices with the correct credentials.

In some embodiments, database 110 is configured to handle large volumes of data generated by the RFID tag 102 and/or other connected devices, such as UE 104. The data not only includes temperature data collected by the RFID tag 102, but also metadata such as timestamps, location information, and sensor status, which are provided by UE 104 in accordance with some embodiments.

In accordance with various embodiments, database 110 employs advanced data storage technologies to ensure data integrity and reliability. This may include the use of redundant storage systems, data replication, and backup mechanisms to protect against data loss and ensure continuous availability. For example, the database 110 may utilize RAID (Redundant Array of Independent Disks) configurations to provide fault tolerance and improve data access speeds.

In some embodiments, database 110 supports various data retrieval and querying capabilities, allowing users to access specific data points or generate reports based on predefined criteria. This functionality allows for compliance with industry regulations, quality control, and auditing purposes. For example, in the healthcare industry, users may need to retrieve historical temperature data for vaccines to ensure compliance with storage requirements and facilitate traceability.

In some embodiments, database 110 is integrated with data analytics tools and platforms, which may be provided by cloud system 108, enabling advanced data analysis and visualization. This integration allows users to perform complex queries, generate insights, and create visual representations of the data. For example, temperature trends can be analyzed to identify patterns or anomalies, and the results can be displayed on interactive dashboards for easy interpretation.

In some embodiments, database 110 includes robust security measures to protect the stored data from unauthorized access and breaches. This may involve encryption of data at rest, access control mechanisms, and regular security audits to ensure compliance with data protection regulations. For example, sensitive data such as personal information and healthcare records can be encrypted using encryption algorithms, and access to the database can be restricted to authorized personnel only.

In some embodiments, database 110 supports data integration and interoperability with other enterprise systems and applications. This allows for seamless data exchange and collaboration across different platforms, enhancing the overall efficiency and effectiveness of the temperature monitoring solution. For example, temperature data from the database 110 can be integrated with a company's inventory management system to optimize stock levels based on real-time conditions.

In some embodiments, database 110 is configured to scale dynamically based on the data storage and processing requirements. This scalability ensures that the system can accommodate increasing data volumes and user demands without compromising performance. For example, as the number of RFID tags and connected devices grows, the database can expand its storage capacity and processing power to handle the additional data load.

FIG. 1B depicts a simplified diagram of an RFID tag with a single antenna according to some embodiments of the present disclosure. The RFID tag includes a first antenna 120, a microchip 124, and an antenna core 126. The first antenna 120 is configured to receive and transmit radio frequency signals to and from an RFID reader. The microchip 124, which includes and/or is integrated with a temperature (or biothermal) sensor, is mounted on the antenna core 126. The antenna core 126 serves as the structural support for the antenna 120 and the microchip 124, and it may be made of a material that enhances the inductive coupling between the antenna and the RFID reader. The temperature sensor within the microchip 124 collects temperature data and transmits it when the tag is powered by the electromagnetic field of UE 104, or its internal power source in accordance with some embodiments, as discussed below.

In some embodiments, the first antenna 120 can be configured for various frequency ranges such as Low Frequency (LF), High Frequency (HF), Ultra-High Frequency (UHF) and limited frequency (e.g., NFC—13.56 MHz, for example). In some embodiments, each frequency range has its own set of antenna types optimized for specific applications:

For example, the first antenna 120 can be a loop antenna in some LF RFID configurations where the RFID operates between 30 and 300 kHz, which may include 125 kHz or 134.2 kHz in some non-limiting embodiments. Loop antennas provide good inductive coupling and can effectively transmit and receive signals over short distances. These antennas may be used in applications such as product tracking or key fobs, as non-limiting examples.

In some embodiments, for HF RFID configurations, which operate at 13.56 MHz, the first antenna 120 can be a loop antenna, a planar spiral antenna, or a coil antenna. These antennas are configured for medium-range applications and provide reliable communication in environments with high levels of interference. Where the RFID tag 102 includes an HF configuration, it can be used in, but not limited to, applications such as contactless payment systems, library book tracking, and smart cards.

In some embodiments, for UHF RFID systems, which operate in the range of 860 MHz to 960 MHz, the first antenna 120 can be a dipole antenna or a patch antenna. Dipole antennas are configured for simplicity and effectiveness in a wide range of frequencies, making them suitable for general-purpose UHF applications. In some embodiments, the patch antenna is used for high-frequency applications and can be easily integrated into compact configurations such as RFID tag 102. The UHF RFID configuration is suitable for use in supply chain management, inventory tracking, and asset management, as non-limiting examples.

The microchip 124 in the RFID tag is configured to execute low-power operations, making it suitable for passive and semi-passive RFID systems. In some embodiments, the microchip 124 includes memory components such as EEPROM (Electrically Erasable Programmable Read-Only Memory) or FRAM (Ferroelectric Random Access Memory) for storing data. The microchip 124 may also include security features such as encryption, authentication, and access control mechanisms to protect the data stored and transmitted by the RFID tag. Additionally, the microchip 124 can be equipped with tamper detection features to detect and respond to physical tampering attempts.

FIG. 1C illustrates a diagram of an RFID tag with two antennas according to some embodiments of the present disclosure. It should be understood that while the discussion herein discloses an RFID tag system with one or two antennas, it should not be construed as limiting, as such disclosure is provided for discussion purposes, and one of ordinary skill in the art would readily understand that any number of antennas and/or types of antennas can be utilized without departing from the scope of the instant disclosure.

Similar to FIG. 1B, RFID tag depicted in FIG. 1C includes a first antenna 120, a second antenna 122, a microchip 124 with an integrated temperature sensor, and an antenna core 126. In some embodiments, for example, the second antenna 122 is positioned on the opposite end of the antenna core 126 from the first antenna 120. The inclusion of the second antenna 122 enhances the RFID tag's ability to communicate with different RFID reader types. Moreover, in some embodiments, the second antenna can be any type of antenna, in a similar manner as discussed in relation to the first antenna 120, discussed supra.

By way of non-limiting example, according to some embodiments, the first antenna 120 can be configured for LF applications, and the second antenna 122 can be configured for High Frequency (HF) applications.

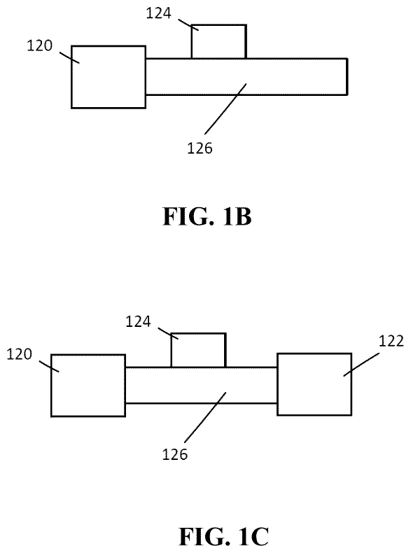

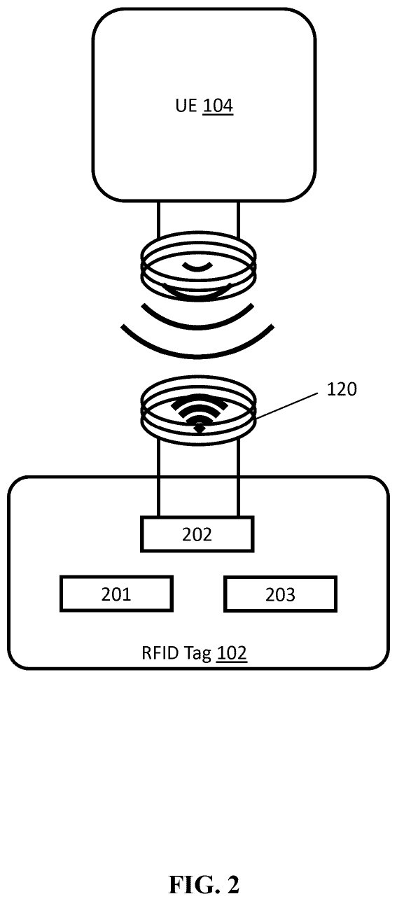

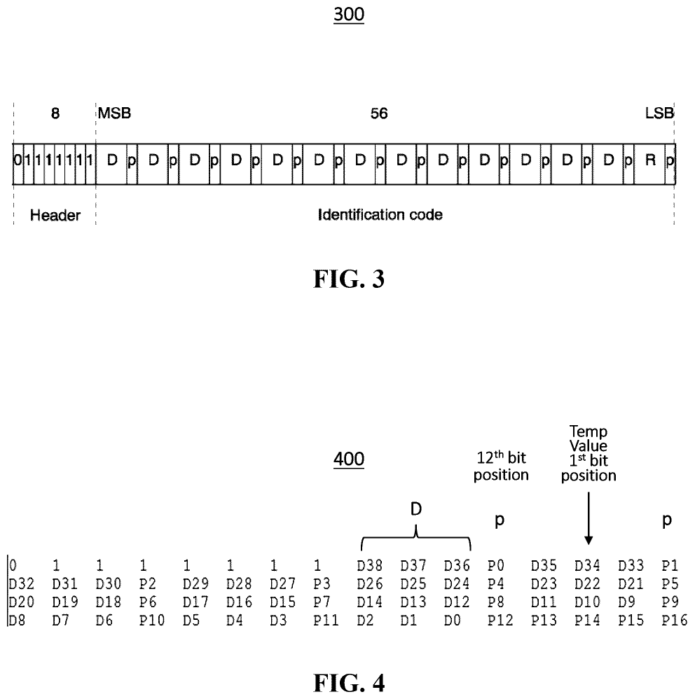

FIG. 2 depicts a non-limiting example embodiment of an inductive coupling (e.g., near field coupling) interaction between UE 104 and the RFID tag 102, where the UE 104 (e.g., RFID reader) generates an electromagnetic field that powers the RFID tag 102. In some embodiments, the RFID tag 102 includes one or more of an antenna 120, a rectifier 201, a load 202, and a controller 203, which can be housed and/or operated on/within microchip 124, as discussed supra. In some embodiments, antenna 120 captures the electromagnetic field generated by the UE 104, and the rectifier 201 converts the captured energy into a usable direct current (DC) power source for the system. Such power source can be used to power the load 202 and controller 203, enabling the RFID tag 102 to communicate the stored code structure (e.g., as discussed with reference to at least FIGS. 3 and 4, infra) to/with the UE 104. In some embodiments, microchip 124 and temperature sensor, which can be function as an IC, as discussed herein, can include controller 204, which may include one or more non-transitory computer readable media that store program instructions that cause one or more processors in microchip 124 to execute instructions, such as the instructions for sending temperature information as discussed in relation to FIG. 4, in addition to other instructions described herein.

FIG. 3 illustrates a 64-bit code structure 300, which can be stored in storage (e.g., memory) associated with the microchip, and provided to the UE 104, which is is configured to read and/or for which cloud system 108 is configured to process, as discussed above. According to some embodiments, the code structure 300 includes various data fields and parity bits, as discussed herein. The code structure 300 is divided into several segments, each serving a specific purpose. In some embodiments, the first 8 bits of the code structure 300 are synchronization bits, represented by the binary sequence 01111111, as a non-limiting example. Such header ensures that the UE 104 can correctly identify the start of the data transmission by providing a consistent and recognizable pattern that signals the beginning of the data stream. This synchronization can be used for the accurate interpretation of the subsequent data bits, as it allows the UE 104 to align its processing with the incoming data, thereby reducing errors and improving communication reliability. Additionally, the header differentiates between various types of data packets, enabling the reader to apply appropriate processing rules based on the type of data being received.

In some embodiments, the next 39 bits are configured to be read by UE 104 as information bits, denoted in groups of three as “D.” These bits contain the actual data transmitted by the RFID tag 102. MSB and LSB refer to the Most Significant Bit and Least Significant Bit, respectively.

The MSB is the bit in a binary number that holds the highest place value. In a binary number, the MSB is located at the far left or the highest position in the bit sequence, and determines the largest contribution to the overall value of the binary number. For example, for the binary number 11010101, the MSB is 1 (the leftmost bit). The LSB is the bit in a binary number that holds the smallest place value. In a binary number, the LSB is located at the far right or the lowest position in the bit sequence. The LSB contributes the least to the overall value of the binary number, and is often used to indicate small changes or fine details in data, such as toggling between two states. For example, for the binary number 11010101, the LSB is 1 (the rightmost bit).

Still referring to FIG. 3, the remaining 17 of the 39 bits are error detection bits or parity bits, denoted as “P.” In some embodiments, such parity bits are dynamically computed by the microchip 124 for each tag transmission. The parity bits ensure data integrity by allowing error detection by UE 104 during data transmission, and are calculated based on the data bits to maintain even or odd parity as required. In some embodiments, P represents row parity bits, ensuring odd parity check for each row of data bits, and R represents column parity bits, ensuring odd parity check for each column of data bits. In some embodiments, the RFID code includes 17 error detection bits. In some embodiments, the UE 104 is configured to process the code into 4 rows. In some embodiments, the UE 104 is configured to code that includes 16 columns. In some embodiments, the code includes at least 3 rows forming 4 columns of parity bits, including a column of 4 parity bits at the end of each of 4 rows, where the header is included in the first row.

Turning now to FIG. 4, the 64-bit code structure 400 stored in the microchip 124 and output by the microchip 124 in the RFID tag 102 is described. In some embodiments, such novel code structure 400 is configured to enable a 10 digit temperature output by the microchip 124 to be compatible with systems, hardware, and protocols configured to process 64 bit RFID code. In some embodiments, this includes the components illustrated in FIG. 1, such as the RFID tag 102, UE 104, network 106, cloud system 108, and/or database 110. By reconfiguring the code as specified herein, there is no need to upgrade the microchip memory to include more bits, or to reconfigure the 64 bit processing algorithms, saving both computer resources and cost.

In some embodiments, the code structure can be divided into several segments, each serving a specific purpose. The first 8 bits of the code structure are the header synchronization bits, represented by the binary sequence 01111111, as a non-limiting example. As discussed previously, this header ensures that the RFID reader can correctly identify the start of the data transmission by providing a consistent and recognizable pattern that signals the beginning of the data stream.

The next 39 bits are information bits, denoted as D as previously described. In some embodiments, these bits are grouped in sets of three and contain the actual data transmitted by the RFID tag, with the fourth bit being a parity bit. In some embodiments, D38 to D35, as depicted in FIG. 4, indicate the type of RFID tag and its features for UE 104. In some embodiments, 0000 indicates a single antenna. In some embodiments, 0001 indicates a dual antenna RFID, such as a LF-NFC combing tag, for example. In some embodiments, 0010 is configured to indicate the RFID tag is a temperature sensor RFID tag. In some embodiments, other four digit code combinations are reserved for identification of other types of tags, such as UHF tags or different combinations of LF, HF, and UHF tags as described above.

According to some embodiments, the four digit code (e.g., the 4 bits) can be used to indicate other types of information, which can be implemented in a non-limiting manner. In some embodiments, for example, the 4 bits can be utilized for temperature and strain applications, which can include, but are not limited to, bending, transmission torque, extension and compressions, weigh scale, and the like, or some combination thereof. In some embodiments, for example, the 4 bits can be utilized for temperature and ambient light applications, which can include, but are not limited to, pack pick-up, smart logistics, smart buildings, and the like, or some combination thereof. In some embodiments, for example, the 4 bits can be utilized for temperature and relative humidity applications, which can include, but are not limited to, humidity, moisture, controlled environments, and the like, or some combination thereof. In some embodiments, the 4 bits can be utilized for temperature and resistive interference applications, which can include, but are not limited to, strain gages, thermocouples, piezoresistive sensors, pressure, battery voltage, and the like, or some combination thereof. And, in some non-limiting embodiments, for example, the 4 bits can be utilized for temperature and capacitive interference applications, which can include, but are not limited to, accelerometers, humidity, permittivity, capacitance, and the like, or some combination thereof. Accordingly, it should be understood that from the above examples, temperature may not be included, as, in some embodiments, strain, ambient light, relative humidity, resistive interference and capacitive interference, and the like, or some combination thereof, may be included in such 4 bits without temperature values.

Accordingly, by reserving 4 bits following the header, there remains sufficient memory for the insertion of the 10-bit (or 9 bit) temperature output from microchip 124, while also allowing for additional information compatible with 64 bit processing systems to be transmitted as well.

In some embodiments, the bits D34 to D25 are used to store the 10-bit temperature sensor payload generated by the microchip 124. In some embodiments, this segment in the 64 code structure is replaced with temperature data by microchip 124 to maintain capability with UE 104. In some embodiments, the bits D24 to D0 correspond to the tag's serial number, which uniquely identifies the RFID tag. In some embodiments, this arrangement allows the 64 bit code read algorithm in UE 104 to remain the same. In various embodiments where a 9 digit temperature is output, the bits D34 to D26 are used to store the 10-bit temperature sensor payload generated by the microchip 102, and the bits D25 to D0 correspond to the tag's serial number. In some embodiments, the first bit representing a temperature output is placed/stored at D34 to ensure system compatibility.

As described above, the remaining 17 bits are error detection bits, denoted as P. In some embodiments, these parity bits are dynamically computed by the microchip 124 for each tag transmission. The parity bits ensure data integrity by allowing error detection during data transmission, and are calculated based on the data bits to maintain even or odd parity as required, in accordance with some embodiments. Specifically, P represents row parity bits, ensuring odd parity check for each row of data bits, and R represents column parity bits, ensuring odd parity check for each column of data bits. In some embodiments, the RFID code includes 17 error detection bits.

In some embodiments, the disclosed code structure includes a first temperature output value to be stored at the 14th bit and/or the 13th non-parity bit (e.g., D34), where the temperature segment includes 10 temperature bits and at least 3 parity bits, wherein the 3 parity bits ensure the integrity of the temperature data. In some embodiments, the temperature segment includes 9 temperature bits and at least 3 parity bits. In some embodiments, each parity bit is not the last bit in a four data bit sequence. This allows all the parity bits to remain in the same position to ensure system compatibility without memory, hardware, or software changes, which overcomes a major problem in the RFID art.

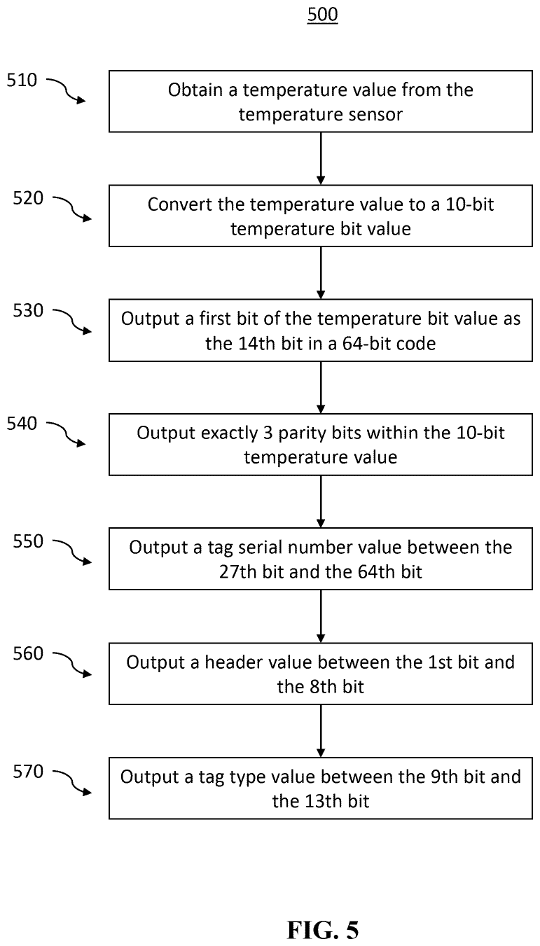

FIG. 5 shows non-limiting program instructions 500 executed by a microchip of the RFID tag in accordance with some embodiments. While the flow diagram shows arrows connecting the steps, the program instructions described herein can be executed in various order by the microchip without departing from the scope of the disclosure. In addition, various other program steps described herein can be inserted between and/or can be executed in conjunction with the program steps listed in FIG. 5, such as those listed below.

Initially, the microchip is powered through inductive coupling between the antenna and an RFID reader. At step 510, the system obtains a temperature value from the temperature sensor that corresponds to a temperature in an environment in which the RFID tag resides. At step 520, the temperature value is converted to a temperature bit value. In some embodiments, the temperature bit value is output using 10 bits. In some embodiments, the microchip creates a 64-bit code that includes the temperature bit value, which is transmitted to the RFID reader via the antenna as a last step after one or more steps listed below, or described elsewhere herein, are executed.

At step 530, the system outputs a first bit of the temperature bit value as the 14th bit. In some embodiments, the system outputs a first bit of the temperature bit value as the 13th non-parity bit. In some embodiments, the temperature bit value is output between the 14th bit and 26th bit.

At step 540, 3 parity bits are inserted within the 10-bit temperature value. In some embodiments, the system ensures that each of the 3 parity bits is not the last value or in the last position in a 4-bit sequence starting from the first bit of the temperature bit value. In some embodiments, each of the 3 parity bits is inserted at the 16-bit, 20-bit, and 24-bit positions, respectively. At step 550, a tag serial value (e.g., number) is inserted between the 27th bit and the 64th bit. In some embodiments, the first value of the tag serial value is represented by the 27th bit. In some embodiments, the tag serial value is configured to identify a product coupled to the RFID tag.

At step 560, a header value is generated by the microchip and placed between the 1st bit and 8th bit. The term “between”, as used herein, includes the numbers recited in the bit range (i.e., bit 1 and bit 8). At step 570, a tag type value is inserted between the 9th bit and the 13th bit. In some embodiments, the tag type value includes 1 parity bit. In some embodiments, the parity bit is not the last number in a 4 bit tag type value. In some embodiments, the first value of the tag type value (e.g., 1 or 0) is represented by the 9th bit. In some embodiments, the tag type value is configured to identify if the RFID tag is a dual antenna tag. In some embodiments, the tag type value is configured to identify if the RFID tag includes a temperature sensor. In some embodiments, the tag type value (e.g., number) is configured to identify if the RFID tag includes a temperature sensor and two antennas.

Accordingly, as discussed above, such output can be provided to a reader (e.g., UE 104), and then transmitted over a network (e.g., network 106) to cloud system 108 and stored in database 110.

According to some embodiments, certain aspects of the instant disclosure can be embodied via functionality discussed herein, as disclosed supra. According to some embodiments, some non-limiting aspects can include, but are not limited to the below device aspects, which can additionally be embodied as method, system and/or apparatus functionality:

Aspect 1. A device comprising:
an antenna configured to communicate with another device, the antenna connected to a core of the device; and
an integrated circuit (IC) including a microchip and temperature sensor, the IC configured to store and communicate information by the device with the other device, the information comprising a code structure modified with a set number of bits for temperature readings by the temperature sensor of the microchip.

Aspect 2. The device of aspect 1, further comprising functionality of the temperature sensor integrated into functionality of the microchip.

Aspect 3. The device of aspect 1, further comprising the microchip and temperature sensor being configured as connected to the core of the device.

Aspect 4. The device of aspect 1, further comprising the microchip having associated memory for storing the information.

Aspect 5. The device of aspect 1, further comprising the code structure being a 64-bit code structure.

Aspect 6. The device of aspect 1, further comprising the code structure comprising:
a header of a set of synchronization bits;
a set of information bits; and
a set of error detection bits.

Aspect 7. The device of aspect 6, further comprising the set of information bits comprising a subset of temperature value bits.

Aspect 8. The device of aspect 6, further comprising the set of information bits further comprising a subset of bits indicating a type of the antenna.

Aspect 9. The device of aspect 8, further comprising the type of antenna being selected from a group consisting of; a legacy antenna, combination antenna and temperature sensor antenna.

Aspect 10. The device of aspect 1, further comprising the device being a Radio Frequency Identification (RFID) tag.

Aspect 11. The device of aspect 1, further comprising the other device being an RF reader.

It should be understood that the disclosed systems are not limited in their application to the details of construction and the arrangement of components set forth in the previous description or illustrated in the drawings. The systems and methods disclosed herein fall within the scope of numerous embodiments. The previous discussion is presented to enable a person skilled in the art to make and use the system according to some embodiments. Any portion of the structures and/or principles included in some embodiments can be applied to any and/or all embodiments, and it should be understood that features from some embodiments presented herein are combinable with other features according to some other embodiments. Thus, some embodiments of the system are not intended to be limited to what is illustrated but are to be accorded the widest scope consistent with all principles and features disclosed herein.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings should be viewed as part of the instant disclosure and should be understood to be readily incorporable into any description of the metes and bounds of the system. Any functional language in the drawings is a reference to the system being configured to perform the recited function, and structures shown or described in the drawings are to be considered as the system including the structures recited therein.

It should be understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A device comprising:
an antenna configured to communicate with another device, the antenna connected to a core of the device; and
an integrated circuit (IC) including a microchip and temperature sensor, the IC configured to store and communicate information by the device with the other device, the information comprising a code structure modified with a set number of bits for temperature readings by the temperature sensor of the microchip, the code structure comprising synchronization header bits, a reserved segment of information bits allocated to represent temperature output from the temperature sensor, and parity bits computed by the microchip.

2. The device of claim 1, further comprising functionality of the temperature sensor integrated into functionality of the microchip.

3. The device of claim 1, further comprising the microchip and temperature sensor being configured as connected to the core of the device.

4. The device of claim 1, further comprising the microchip having associated memory for storing the information.

5. The device of claim 1, further comprising the code structure being a 64-bit code structure.

6. The device of claim 1, further comprising the code structure further comprising:
a set of information bits; and
a set of error detection bits.

7. The device of claim 6, further comprising the set of information bits comprising a subset of temperature value bits.

8. The device of claim 6, further comprising the set of information bits further comprising a subset of bits indicating a type of the antenna.

9. The device of claim 8, further comprising the type of antenna being selected from a group consisting of, a legacy antenna, combination antenna and temperature sensor antenna.

10. The device of claim 1, further comprising the device being a Radio Frequency Identification (RFID) tag.

11. The device of claim 1, further comprising the other device being an RF reader.

12. A Radio Frequency Identification (RFID) tag comprising:
an antenna, a temperature sensor, and a microchip, wherein:
the microchip, integrated with the temperature sensor, being powered via inductive coupling between the antenna and an RFID reader, the microchip comprising functionality for:
obtain a temperature value from the temperature sensor that corresponds to a temperature in an environment in which the RFID tag resides;
convert the temperature value to a temperature bit value;
generate a 64-bit code that includes the temperature bit value; and
transmit the 64-bit code to the RFID reader via the antenna.

13. The RFID tag of claim 12, further comprising the microchip further outputting the temperature bit value between a 14th bit and 26th bit of the 64-bit code.

14. The RFID tag of claim 12, further comprising the temperature bit value including 10 bits, wherein 3 parity bits are within the 10-bit temperature value.

15. The RFID tag of claim 12, further comprising the 64-bit code comprising a subset of bits corresponding to tag serial identifications.

16. The RFID tag of claim 12, further comprising the 64-bit code including information bits for housing information communicated by the antenna.

17. A method comprising:
receiving, by an antenna of a device, a signal from another device;
receiving, by a microchip of the device, information, corresponding to at least a signal and temperature value; and
storing, by the microchip of the device, the information within a code structure, the code structure specifically configured to house synchronization header bits, the temperature value as part of a set of bits as a reserved segment of information bits, and parity bits computed by the microchip.

18. The method of claim 17, further comprising:
communicating, by the device, data related to the code structure to the other device, wherein the other device communicates with a cloud.

19. The method of claim 17, further comprising the information further comprising subset of data indicating a type of the antenna, the subset data stored as part of information bits of the code structure.

20. The method of claim 17, further comprising the device being a Radio Frequency Identification (RFID) tag.
